(19) United States
(12) Patent Application Publication
(10) Pub. No.: US 2007/0064750 A1
(43) Pub. Date: Mar. 22, 2007

(54) Deep ultraviolet laser apparatus

(75) Inventors: Yushi Kaneda, Wako-shi (JP); Yoshiharu Urata, Wako-shi (JP); Satoshi Wada, Wako-shi (JP); Shinichi Imai, Kawasaki-shi (JP)

Correspondence Address: BIRCH STEWART KOLASCH & BIRCH, PO BOX 747, FALLS CHURCH, VA, 22040-0747, US

(73) Assignees: Megaopto Co., Ltd.; Advanced Mask Inspection Technology Inc.

(21) Appl. No.: 11/523,028

(22) Filed: Sep. 19, 2006

(30) Foreign Application Priority Data
Sep. 20, 2005 (JP) 2005-271357

(51) Int. Cl. H01S 3/10

(52) U.S. Cl. 372/21

(57) ABSTRACT

The present invention provides a deep ultraviolet laser apparatus exhibiting high robustness which can generate laser beams in a wavelength region of wavelengths of from 198.3 to 198.8 nm, further may be loaded on a variety of apparatuses as a light source for lighting, and is practicable and a size of the whole structure of thereof is reduced. The deep ultraviolet laser apparatus is arranged in such that laser beams having a wavelength of from 1064 to 1065 nm pulse-output from a first light source is a first fundamental wave; fourth harmonic obtained by wavelength-converting the first fundamental wave by means of a first wave-length conversion means is a second fundamental wave; laser beams having a wavelength of from 1560 to 1570 nm pulse-output from a second light source is a third fundamental wave; second harmonic obtained by wavelength-converting the third fundamental wave by means of a second wave-length conversion means is a fourth fundamental wave; and laser beams having a wavelength of from 198.3 to 198.8 nm which are a sum-frequency light of the second fundamental wave and the fourth fundamental wave are generated by means of a sum-frequency wave generation means.

### BACKGROUND OF THE INVENTION

1. Field of the Invention

The present invention relates to a deep ultraviolet laser apparatus, and more particularly to a deep ultraviolet laser apparatus for generating deep ultraviolet laser beam by utilizing nonlinear optical effects.

2. Description of the Related Art

In general, a micropattern used for manufacturing semiconductors and the like is recognized and inspected by the use of a laser beam wherein a continuous light source is used frequently as a light source applied in lighting for such recognition and inspection.

Recently, with the progress of further intensifying the micropattern used for inspection and the like, a development directing to making the wavelength shorter in the light source used for lighting the inspection and the like has been made in order to improve optical resolution.

In these circumstances, such a manner that a laser beam of long wavelength laser oscillating continuously is wavelength-converted to the side of a shorter wavelength by using the long wavelength laser as its fundamental harmonic is carried out for obtaining a continuous light source of a short wavelength. More specifically, the manner is such that a long wavelength laser beam is made to be a shorter wavelength laser beam by means of sum-frequency generation with the use of the laser beam having a longer wavelength than a desired wavelength as its fundamental harmonic while maintaining continuous oscillation of the laser beam of such longer wavelength than the desired wavelength.

Such wavelength conversion as mentioned above is in a nonlinear process utilizing nonlinear optical effects; and a high electric field is required for improving the conversion efficiency therefor.

In this respect, however, continuous oscillation of a long wavelength laser beam provides essentially a low electric field; so that it is pointed out that a special conversion technique is required for implementing the wavelength conversion.

As the special conversion technique, for example, it is proposed to use a nonlinear crystal being a nonlinear medium inside a resonator having a structure for confining fundamental harmonic in order to improve the electric field intensity in a nonlinear medium.

As the structure of a resonator for sum-frequency generation being an example of such proposal as mentioned above, a manner according to an internal resonator wherein a laser amplification medium is located in the resonator; and a manner according to an external resonator wherein a fundamental harmonic generation source is allowed to be independent from a resonator for sum-frequency generation are known (for example, see Japanese Patent Application Laid-Open No. 10-341054 submitted as a patent literary document 1).

However, there is such a problem that when a resonator device having the structure as described above is introduced into a part of a light source for generating a fundamental harmonic (a laser beam of a long wavelength), the whole structure of the apparatus becomes extremely jumboized. Besides there is a problem of being easily affected by disturbance, and in addition, there is a problem of requiring much time for the maintenance because of its complicated structure of the apparatus. Moreover, there are such problem that a run length of the apparatus during which no maintenance is required is restricted; and the like problems.

More than that described above, when, for example, an argon laser or the like is used for a part of a light source for generating a fundamental harmonic (a laser beam of a long wavelength), there is such a problem that the whole structure of the apparatus becomes further jumboized.

On the other hand, a short wavelength laser light source wherein pulsed laser radiation by which a high electric field is easily obtained has heretofore been also proposed. In the research paper submitted as non-patent literary document 1 and Japanese Patent Application Laid-Open No. 2001-83557 submitted as patent literary document 2, a short wavelength laser beam source for generating pulsed laser radiation of 193 nm wavelength by means of higher harmonics of a fundamental wave is disclosed.

In the meantime, the inventors of this application has found that the shortest wavelength which is the most suitable for using transmission optics as a short wavelength light source for inspection is around 197 nm. The main reasons of that the wavelength of around 197 nm is preferred are in that quartz components may be used as the optical components, and that absorption of air may be ignored. As described in the research paper submitted as a non-patent literary document 2, a part of the inventor realizes a light source having 199 nm wavelength as to continuous light.

As described above, although the shortest wavelength which is the most suitable for using transmission optics as a short wavelength light source for inspection is around 197 nm, a short wavelength is realized by high harmonic generation of a fundamental wave in a conventional short wavelength laser beam source wherein pulsed laser radiation is used. Accordingly, there is such a problem that no generated wavelength is obtained in a wavelength region of the shortest wavelength of around 197 nm which is the most suitable for using the transmission optics as the short wavelength light source for inspection.

Moreover, a variety of all the conventional light source apparatuses as described above have a large size; so that it is difficult to unite them with a section to be lit as a lighting source, and as a result, there is such a problem that a good deal of effort must be expensed for operation and maintenance of the optical axis.

Patent literary document 1: Japanese Patent Application Laid-Open No. 10-341054

Patent literary document 2: Japanese Patent Application Laid-Open No. 2001-83557

Non-patent literary document 1: The 23rd Annual Conference on Lasers and Electro-Optics (CLEO 2003) and the 11th Quantum Electronics and Laser Science Conference (QELS 2003) Research Paper No. CTuT4

Non-patent literary document 2: OSA TOPS83 (2003) 380-383

### OBJECT AND SUMMARY OF THE INVENTION

The present invention has been made in view of the above-described problems involved in the prior art, and an object of the invention is to provide a deep ultraviolet laser apparatus exhibiting high robustness which can generate laser beams in a wavelength region of wavelengths of from 198.3 to 198.8 nm, further may be loaded on a variety of apparatuses as a light source for lighting, and is practicable and a size of the whole structure thereof is reduced.

In order to achieve the above-described object, the deep ultraviolet laser apparatus according to the present invention is arranged to generate laser beams having 198.3 nm to 198.8 nm wavelengths by means of sum-frequency mixing of fourth harmonic of laser beams having 1064 to 1065 nm wavelengths and second harmonic of laser beams having 1560 to 1570 nm wavelengths.

Namely, the present invention may be a deep ultraviolet laser apparatus including laser beams having a wavelength of from 1064 to 1065 nm pulse-output from a first light source being a first fundamental wave; fourth harmonic obtained by wavelength-converting the first fundamental wave by means of a first wave-length conversion means being a second fundamental wave; laser beams having a wavelength of from 1560 to 1570 nm pulse-output from a second light source being a third fundamental wave; second harmonic obtained by wavelength-converting the third fundamental wave by means of a second wave-length conversion means being a fourth fundamental wave; and laser beams having a wavelength of from 198.3 to 198.8 nm which are a sum-frequency light of the second fundamental wave and the fourth fundamental wave being generated by means of a sum-frequency wave generation means.

Furthermore, in the deep ultraviolet laser apparatus according to the present invention, the first light source and the first wavelength conversion means may be installed in casings independent from one another wherein the first light source is connected to the first wavelength conversion means through a first optical fiber for transmission; and the second light source and the second wavelength conversion means may be installed in casings independent from one another wherein the second light source is connected to the second wavelength conversion means through a second optical fiber for transmission.

Moreover, in the deep ultraviolet laser apparatus according to the present invention, the first light source may be composed of a first semiconductor laser pulse-outputting laser beams having a wavelength of from 1064.0 to 1065.0 nm by means of current modulation, and the first optical fiber amplifier for amplifying the laser beams having the wavelength of 1064.0 to 1065.0 nm output from the first semiconductor laser; and the second light source may be composed of a second semiconductor laser pulse-outputting laser beams having a wavelength of from 1560 to 1570 nm by means of current modulation, and the second optical fiber amplifier for amplifying the laser beams having the wavelength of 1560 to 1570 nm output from the second semiconductor laser.

Still further, in the deep ultraviolet laser apparatus according to the present invention, the sum-frequency generation means may contain a nonlinear optical crystal; and the second fundamental wave and the fourth fundamental wave may be axially input to the nonlinear optical crystal.

Yet further, in the deep ultraviolet laser apparatus according to the present invention, the second fundamental wave and the fourth fundamental wave may be input to the nonlinear optical crystal through a single condensation system.

Besides, in the deep ultraviolet laser apparatus according to the present invention, a current modulation frequency of the first semiconductor laser and the second semiconductor laser may be 100 kHz or more.

Since the present invention is constituted as described above, it provides such an excellent advantageous effect that the resulting deep ultraviolet apparatus exhibiting high robustness can generate laser beams in a wavelength region of wavelengths of from 198.3 to 198.8 nm, further may be loaded on a variety of apparatuses as a light source for lighting, and is practicable and a size of the whole structure thereof is reduced.

The present invention as mentioned above is applicable in case of manufacturing pulse width variable laser apparatuses in laser apparatus makers, implementing experiments wherein a pulsed laser is used in a variety of laser experimental facilities, or in the like cases.

Furthermore, the present invention is applicable for a light source of lighting used in recognition or inspection of micropattern, a system for generating the light therefor and the like in semiconductor manufacturing fields and the like.

### BRIEF DESCRIPTION OF THE DRAWING

The present invention will become more fully understood from the detailed description given hereinbelow and the accompanying drawings which are given by way of illustration only, and thus are not limitative of the present invention, and wherein:

FIG. 1 is a conceptual constitutional explanatory view showing a deep ultraviolet laser apparatus according to an example of a manner of practice of the present invention; and

FIG. 2 is a schematic constitutional explanatory diagram showing optics being the substantial part of the deep ultraviolet laser apparatus shown in FIG. 1.

### DETAILED DESCRIPTION OF THE PREFERRED EMBODIMENTS

In the following, an example of a manner of practice of the deep ultraviolet laser apparatus according to the present invention will be described in detail by referring to the accompanying drawings.

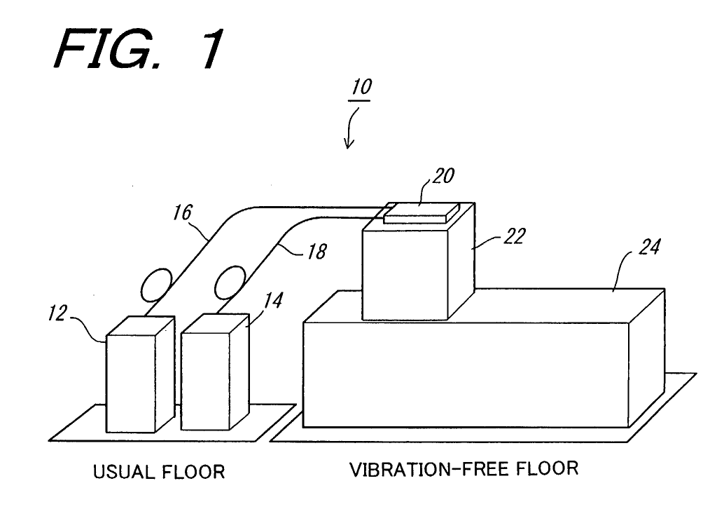

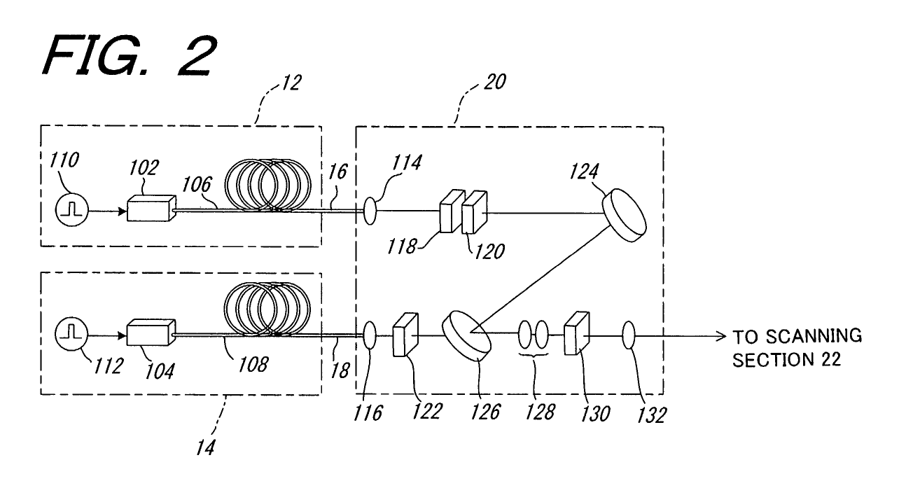

FIG. 1 is a conceptual constitutional explanatory view showing a deep ultraviolet laser apparatus according to an example of a manner of practice of the present invention, and FIG. 2 is a schematic constitutional explanatory diagram showing optics being the substantial part of the deep ultraviolet laser apparatus shown in FIG. 1.

Referring appropriately to FIGS. 1 and 2, the deep ultraviolet laser apparatus 10 according to the present invention is composed of a first fundamental wave light source 12 set up on a usual floor and for generating a first fundamental wave, a second fundamental wave light source 14 set up on a usual floor and for generating a second fundamental wave, a wavelength conversion section 20 connected to the first fundamental wave light source 12 through a first optical fiber 16 for transmission and further connected to the second fundamental wave light source 14 through a second optical fiber 18 for transmission, a scanning section 22 connected to the wavelength conversion section 20 to irradiate a deep ultraviolet laser beam output from the wavelength conversion section 20 onto a lighting object (not shown) disposed inside a section to be lit 24 (which will be mentioned later) while scanning the lighting object, and the section to be lit 24 set up on a vibration-free floor, containing the lighting object (not shown) inside thereof, and connected to a scanning section 22.

The first fundamental wave light source 12, the second fundamental wave light source 14, the wavelength conversion section 20, the scanning section 22, and the section to be lit 24 are placed respectively in an independent casing.

The first fundamental wave light source 12 is composed of a first semiconductor laser 102 for outputting laser beams having 1064 to 1065 nm wavelengths, a first optical fiber amplifier 106 for amplifying the laser beams having 1064 to 1065 nm wavelengths output from the first semiconductor laser 102, and a first pulse current source 110 for driving the first semiconductor laser 102.

In the manner of practice, a quartz fiber to which Yb is added as an active substance is used for the first optical fiber amplifier 106.

Furthermore, since exclusive parts which have been heretofore well known as optical communication parts may be used in case of connecting respective optics constituting the above-described first fundamental wave light source 12, explanations for the detailed constitutions and functions thereof are omitted.

Moreover, all the polarized phases of the respective optics constituting the first fundamental wave light source 12 are conserved.

The output from the first fundamental wave light source 12 is transmitted to the wavelength conversion section 20 through the first optical fiber 16 for transmission connected to the end of the first optical fiber amplifier 106.

Next, the second fundamental wave light source 14 is composed of a second semiconductor laser 104 for outputting laser beams having 1560 to 1570 nm wavelengths, a second optical fiber amplifier 108 for amplifying the laser beams having 1560 to 1570 nm wavelengths output from the second semiconductor laser 104, and a second pulse current source 112 for driving the second semiconductor laser 104. In the manner of practice, a quartz fiber to which Er is added as an active substance is used for the second optical fiber amplifier 108.

Furthermore, since exclusive parts which have been heretofore well known as optical communication parts may be used in case of connecting respective optics constituting the above-described second fundamental wave light source 14, explanations for the detailed constitutions and functions thereof are omitted.

Moreover, all the polarized phases of the respective optics constituting the second fundamental wave light source 14 are conserved.

The output from the second fundamental wave light source 14 is transmitted to the wavelength conversion section 20 through the second optical fiber 18 for transmission connected to the end of the second optical fiber amplifier 108.

Next, the wavelength conversion section 20 is composed of a first condenser lens 114 for condensing laser beams having 1064 to 1065 nm wavelengths output from the end of the first optical fiber 16 for transmission connected to the first optical fiber amplifier 106, a first nonlinear optical crystal 118 for inputting laser beams having 1064 to 1065 nm output from the first condenser lens 114 to output laser beams having 532 to 532.5 nm wavelengths as second harmonic, a second nonlinear optical crystal 120 for inputting the laser beams having 532 to 532.5 nm wavelengths output from the first nonlinear optical crystal 118 to output laser beams having 266 to 266.25 nm wavelengths as fourth harmonic of the laser beams having 1064 nm to 1065 nm wavelengths, a second condenser lens 116 for condensing the laser beams having 1560 to 1570 mm wavelengths output from the end of the second optical fiber 18 for transmission connected to the second optical fiber amplifier 108, a third nonlinear optical crystal 122 for inputting the laser beams having 1560 to 1570 nm wavelengths output from the second condenser lens 116 to output laser beams having 780 to 785 nm wavelengths as the second harmonic, a reflection mirror 124 for reflecting the laser beams having 266 to 266.25 nm wavelengths output from the second nonlinear optical crystal 120, a coupling mirror 126 for coupling the laser beams having 266 to 266.25 nm wavelengths reflected by the reflection mirror 124 with the laser beams having 780 to 785 nm wavelengths output from the third nonlinear optical crystal 122, a matching lens system 128 for matching the light beams output from the coupling mirrors 126, a sum-frequency generation nonlinear optical crystal 130 for generating laser beams having 198.3 to 198.8 nm wavelengths by means of wavelength conversion due to sum-frequency generation of the laser beams having 266 to 266.25 nm wavelengths output from the matching lens system 128 and laser beams having 780 to 785 nm wavelengths, and a collimator lens 132 for outputting the laser beams having 198.3 to 198.8 nm wavelengths output from the sum-frequency generation optical crystal 130 as parallel lights.

In the manner of practice, a KTP crystal is used as the first nonlinear optical crystal 118, a BBO crystal is used as the second nonlinear optical crystal 120, a LBO crystal is used as the third nonlinear optical crystal 122, and a BBO crystal is used as the fourth nonlinear optical crystal 130.

In the above-described constitution, operations of the deep ultraviolet laser apparatus 10 will be described wherein a semiconductor laser having 1064 nm laser oscillation wavelength and exhibiting 100 mW average output in case of continuous operation is used as the first semiconductor laser 102, while another semiconductor laser having 1562 nm laser oscillation wavelength and exhibiting 80 mW average output in case of continuous operation is used as the second semiconductor laser 104.

In order to laser-oscillate the above-described first semiconductor laser 102, when the first pulse current source 110 is driven in such that the driving current of the first semiconductor laser 102 becomes 2 MHz and the pulse width of its driving current waveform is made to be 2 ns, a laser pulse having 1.5 ns pulse width is obtained as a laser beam having 1064 nm wavelength output from the first semiconductor laser 102; and the average output obtained at that time was 0.3 mW. When the output of the first semiconductor laser 102 is introduced into the first optical fiber amplifier 106, 5 W average output is obtained, and the laser beams thus amplified are transmitted to the wavelength conversion section 20 through the first optical fiber 16 for transmission.

On the other hand, for the sake of laser-oscillating the above-described second semiconductor laser 104, when the second pulse current source 112 is driven in such that the driving current of the second semiconductor laser 104 becomes 2 MHz and the pulse width of its driving current waveform is made to be 2 ns, a laser pulse having 1.5 ns pulse width is obtained as a laser beam having 1562 nm wavelength output from the second semiconductor laser 104; and the average output obtained at that time was 0.24 mW. When the output of the second semiconductor laser 104 is introduced into the second optical fiber amplifier 108, 5 W average output is obtained, and the laser beams thus amplified are transmitted to the wavelength conversion section 20 through the second optical fiber 18 for transmission.

It was possible to drive the second semiconductor laser 104 simultaneously with the first semiconductor laser 102 and to operate it in jitter of 80 ps or less.

In accordance with the manner as described above, the laser beam having 1064 nm wavelength transmitted to the wavelength conversion section 20 through the first optical fiber 16 for transmission is input to the first nonlinear optical crystal 118 wherein second harmonic generation is effected, whereby the laser beam having 532 nm wavelength is output from the first nonlinear optical crystal 118. Then, the laser beam having 532 nm wavelength output from the first nonlinear optical crystal 118 is thereafter input further to the second nonlinear optical crystal 120 wherein second harmonic is further effected, whereby the laser beam having 266 nm wavelength is output from the second nonlinear optical crystal 120. The resulting laser beam having 266 nm wavelength is fourth harmonic of the laser beam of 1064 nm.

On one hand, the laser beam having 1562 nm wavelength transmitted to the wavelength conversion section 20 through the second optical fiber 18 for transmission is input to the third nonlinear optical crystal 122 wherein second harmonic is effected, whereby the laser beam having 781 nm wavelength is output from the third nonlinear optical crystal 122.

Furthermore, the laser beam having 266 nm wavelength is coupled with the laser beam having 781 nm wavelength following to the above-described wavelength conversion in the wavelength conversion section 20.

Namely, the laser beam having 266 nm wavelength output from the second nonlinear optical crystal 120 turns the light path through the reflection mirror 124, and is input to the coupling mirror 126.

On one hand, the laser beam having 781 nm wavelength output from the third nonlinear optical crystal 122 is also input to the coupling mirror 126, and is coupled with the laser beam of 266 nm wavelength.

Then, the laser beam having 266 nm wavelength and the laser beam having 781 nm wavelength coupled with the coupling mirror 126 are input to the fourth nonlinear optical crystal 130 being a nonlinear optical crystal for sum-frequency generation after these coupled laser beams were passed through a lens system 128 wherein a ultraviolet laser beam having about 198.4 nm wavelength which is a sum-frequency of 266 nm wavelength and 781 nm wavelength is output from the fourth nonlinear optical crystal 130 as a result of sum-frequency generation.

In the case where the laser beam of 266 nm wavelength and the laser beam of 781 nm laser beam are input to the fourth nonlinear optical crystal 130, if the both laser beams are input coaxially to the fourth nonlinear optical crystal 130, it becomes possible to maintain a phase matching condition.

According to the experiments by the inventor of this application, when frequencies of the driving current pulses for driving the first semiconductor laser 102 and the second semiconductor laser 104 are changed in the deep ultraviolet laser apparatus 10, it was possible to change output repetition frequencies of the deep ultraviolet laser beam within a range of from 100 kHz to 10 MHz.

In these circumstances, the inventor of this application has found that the deep ultraviolet laser apparatus 10 according to the present invention may be applied to the use application in which a continuous light has been used heretofore so far as the condition is in such that an image acquisition is made with a charge storage device in a conventional system wherein the image acquisition is carried out by the use of a continuous light; and the repetition frequency of its light source is 100 kHz or more. In other words, it has been confirmed by the experiments according to the inventor of this application that when a light source repetition frequency of a value equal to the frame rate or more of the image acquisition means is obtained, the deep ultraviolet laser apparatus 10 may be applied as the light source.

According to the above-described deep ultraviolet laser apparatus 10, not only a compact ultraviolet light source having remarkably higher efficiency than that of a conventional light source can be realized, but also the first fundamental wave light source 12 and the second fundamental wave light source 14 may be composed of a semiconductor laser and an optical fiber amplifier being longer lasting devices, whereby it may be intended to make the whole apparatus longer lasting.

Moreover, according to the deep ultraviolet laser apparatus 10, since the first fundamental wave light source 12 is connected to the wavelength conversion section 20 through the first optical fiber 16 for transmission, while the second fundamental wave light source 14 is connected to the wavelength conversion section 20 through the second optical fiber 18 for transmission, the wavelength conversion section 20 which is composed of optical parts required for maintenance, respectively, may be contained in a casing independent from the casings for the first and second fundamental wave light sources 12 and 14, whereby the operation and maintenance of the whole apparatus become easy.

Furthermore, according to the deep ultraviolet laser apparatus 10, as the fundamental wave light source 12 and the second fundamental wave light source 14; and the wavelength conversion section 20, the scanning section 22 and the section to be lit 24 are connected through the first optical fiber 16 for transmission, and the second optical fiber 18 for transmission, each group of them may be set out on different floors, respectively, so that a degree of freedom in the constitution may be remarkably improved.

Still further, in an apparatus which has been used heretofore by the inventor of this application wherein an argon laser is used as the light source, 50 kW electric power and cooling water of 50 liters per minute have been required, but the electric power consumption becomes 500 W which is hundredth part of the former electric power consumption, besides no cooling water is required in the present deep ultraviolet laser apparatus 10.

Yet further, in an apparatus which has been used heretofore by the inventor of this application wherein an argon laser is used as the light source, an exclusive place for a space of setting the light source is required, but when only the scanning section 22 and the compact wavelength conversion section 20 are installed in the section to be lit 24, and when the first fundamental wave light source 12 and the second fundamental wave light source 14 or the like are contained in the same rack as that of a control system of the section to be lit 24, the place for setting exclusively the light source becomes unnecessary according to the deep ultraviolet laser apparatus 10.

Besides, in the case when the section to be lit 24 accompanies oscillations, a vibration-free countermeasure is applied only to the first fundamental wave light source 12 and the second fundamental wave light source 14, while it is sufficient to apply a usual vibration-free countermeasure to the rest of the components, and thus, it becomes possible to reduce significantly the manufacturing cost.

It is to be noted that the above-described manners of practice may be modified as described in the following paragraphs (1) to (3).

(1) In the above-described manners of practice, although the quartz fiber to which Yb is added as an active substance is used as the first optical amplifier 106, while the other quartz fiber to which Er is added as an active substance is used as the second optical amplifier 108, the invention is not restricted thereto as a matter of course. Furthermore, a material of the fiber is not limited to quartz, but the other materials may be used as a matter of course, so far as they are transparent materials with respect to a laser beam to be amplified.

(2) In the above-described manners of practice, although a KTP crystal is used as the first nonlinear optical crystal 118, a BBO crystal is used as the second nonlinear optical crystal 120, a LBO crystal is used as the third nonlinear optical crystal 122, and a BBO crystal is used as the above-described fourth nonlinear optical crystal 130, the nonlinear optical crystals used in the respective wavelength conversions are not limited thereto as a matter of course, but the other crystals may be properly used, of course, so far as they are transparent in the respective wavelengths in case of the wavelength conversion and they are phase-matched in the respective wavelength conversion processes.

(3) The above-described manners of practice as well as the modifications described in the above paragraphs (1) and (2) may be properly combined with each other.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

The entire disclosure of Japanese Patent Application No. 2005-271357 filed on Sep. 20, 2005 including specification, claims, drawing and summary are incorporated herein by reference in its entirety.

What is claimed is:

1. A deep ultraviolet laser apparatus, comprising:
laser beams having a wavelength of from 1064 to 1065 nm pulse-output from a first light source being a first fundamental wave;
fourth harmonic obtained by wavelength-converting the first fundamental wave by means of a first wave-length conversion means being a second fundamental wave;
laser beams having a wavelength of from 1560 to 1570 nm pulse-output from a second light source being a third fundamental wave;
second harmonic obtained by wavelength-converting the third fundamental wave by means of a second wave-length conversion means being a fourth fundamental wave; and
laser beams having a wavelength of from 198.3 to 198.8 nm which are a sum-frequency light of the second fundamental wave and the fourth fundamental wave being generated by means of a sum-frequency wave generation means.

2. The deep ultraviolet laser apparatus as claimed in claim 1, wherein:
the first light source and the first wavelength conversion means are installed in casings independent from one another wherein the first light source is connected to the first wavelength conversion means through a first optical fiber for transmission; and
the second light source and the second wavelength conversion means are installed in casings independent from one another wherein the second light source is connected to the second wavelength conversion means through a second optical fiber for transmission.

3. The deep ultraviolet laser apparatus as claimed in any one of claims 1 and 2, wherein:
the first light source is composed of a first semiconductor laser pulse-outputting laser beams having a wavelength of from 1064.0 to 1065.0 nm by means of current modulation, and the first optical fiber amplifier for amplifying the laser beams having the wavelength of 1064.0 to 1065.0 nm output from the first semiconductor laser; and
the second light source is composed of a second semiconductor laser pulse-outputting laser beams having a wavelength of from 1560 to 1570 nm by means of current modulation, and the second optical fiber amplifier for amplifying the laser beams having the wavelength of 1560 to 1570 nm output from the second semiconductor laser.

4. The deep ultraviolet laser apparatus as claimed in any one of claims 1 and 2, wherein:
the sum-frequency generation means contains a nonlinear optical crystal; and the second fundamental wave and the fourth fundamental wave are axially input to the nonlinear optical crystal.

5. The deep ultraviolet laser apparatus as claimed in claim 3, wherein:
the sum-frequency generation means contains a nonlinear optical crystal; and the second fundamental wave and the fourth fundamental wave are axially input to the nonlinear optical crystal.

6. The deep ultraviolet laser apparatus as claimed in claim 4, wherein:
the second fundamental wave and the fourth fundamental wave are input to the nonlinear optical crystal through a single condensation system.

7. The deep ultraviolet laser apparatus as claimed in claim 5, wherein:
the second fundamental wave and the fourth fundamental wave are input to the nonlinear optical crystal through a single condensation system.

8. The deep ultraviolet laser apparatus as claimed in any one of claims 1 and 2, wherein:
a current modulation frequency of the first semiconductor laser and the second semiconductor laser is 100 kHz or more.

9. The deep ultraviolet laser apparatus as claimed in claims 3, wherein:
a current modulation frequency of the first semiconductor laser and the second semiconductor laser is 100 kHz or more.

10. The deep ultraviolet laser apparatus as claimed in claims 4, wherein:
a current modulation frequency of the first semiconductor laser and the second semiconductor laser is 100 kHz or more.

11. The deep ultraviolet laser apparatus as claimed in claims 5, wherein:
a current modulation frequency of the first semiconductor laser and the second semiconductor laser is 100 kHz or more.

12. The deep ultraviolet laser apparatus as claimed in claims 6, wherein:
a current modulation frequency of the first semiconductor laser and the second semiconductor laser is 100 kHz or more.

13. The deep ultraviolet laser apparatus as claimed in claims 7, wherein:
a current modulation frequency of the first semiconductor laser and the second semiconductor laser is 100 kHz or more.
